(19) United States
(12) Patent Application Publication
(10) Pub. No.: US 2007/0056465 A1
(43) Pub. Date: Mar. 15, 2007

(54) Rapid generation of nanoparticles from bulk solids at room temperature

(75) Inventor: Partha Dutta, Clifton Park, NY (US)

Correspondence Address: FOLEY AND LARDNER LLP;SUITE 500, 3000 K STREET NW, WASHINGTON, DC, 20007, US

(73) Assignee: RENSSELAER POLYTECHNIC INSTITUTE, TROY NEW YORK, NY (US)

(21) Appl. No.: 10/547,795

(22) PCT Filed: Mar. 3, 2004
(86) PCT No.: PCT/US04/06350

§ 371 Date: Aug. 8, 2006

Related U.S. Application Data
(60) Provisional application No. 60/452,041, filed on Mar. 6, 2003.

(51) Int. Cl. B32B 1/00; B32B 15/02; C09G 1/02

(52) U.S. Cl. 106/3; 428/403; 428/404; 428/323; 428/331

(57) ABSTRACT

A plurality of nanoparticles are provided. The nanoparticles may have a metal oxide or a semiconductor oxide surface region and a metal or semiconductor core region and/or the nanoparticles may be uniformly doped. The nanoparticles are formed by grinding a bulk material to a powder and then etching the powder in a solution to a desired nanoparticle size.

### FIELD OF THE INVENTION

The present invention is directed generally to compositions of matter and more particularly to nanoparticles and methods of making thereof.

### BACKGROUND OF THE INVENTION

In principle, nanoparticles of any material can be generated by thoroughly grinding a bulk solid of the given material, by a grinding process such as ball milling, as discussed, for example, in “Large-scale synthesis of ultrafine Si nanoparticles by ball milling” C. Lam, Y. F. Zhang, Y. H. Tang, C. S. Lee, I. Bello, S. T. Lee, Journal of Crystal Growth 220 (2000) 466-470. However as simple as it may appear, grinding does not lead to uniform particle sizes due to aggregation of the particles after they have been crushed and powdered to sub-micron chunks. To get nanoparticles below 100 nm, it may take up to several days of grinding, making the grinding process, such as a ball milling process, unsuitable for large scale production. When nanoparticles are produced by ball milling for a prolonged period of time, such as for several days, the nanoparticles are frequently contaminated and undesirable impurities of foreign materials have been detected in such nanoparticle samples. Thus, many commercial nanoparticle synthesis methods use high temperature processes, including formation of nanoparticles by reaction from chemicals or physical disintegration of big particles by pyrolysis. However, these methods are often complex, expensive, difficult to control due to the high process temperature and often use environmentally harmful and dangerous chemicals.

A relatively new correlative method for easier manipulation and spatial organization of the nanoparticles has been proposed in which the nanoparticles are encapsulated in a shell. The shells which encapsulate the nanoparticles are composed of various organic materials such as Polyvinyl Alcohol (PVA), PMMA, and PPV. Furthermore, semiconductor shells have also been suggested.

For example, U.S. Pat. Nos. 6,225,198 and 5,505,928, incorporated herein by reference, disclose a method of forming nanoparticles using an organic surfactant. The process described in the U.S. Pat. No. 6,225,198 patent includes providing organic compounds, which are precursors of Group II and Group VI elements, in an organic solvent. A hot organic surfactant mixture is added to the precursor solution. The addition of the hot organic surfactant mixture causes precipitation of the II-VI semiconductor nanoparticles. The surfactants coat the nanoparticles to control the size of the nanoparticles. However, this method is disadvantageous because it involves the use of a high temperature (above 200° C.) process and toxic reactants and surfactants. The resulting nanoparticles are coated with a layer of an organic surfactant and some surfactant is incorporated into the semiconductor nanoparticles. The organic surfactant negatively affects the optical and electrical properties of the nanoparticles.

In another prior art method, II-VI semiconductor nanoparticles were encapsulated in a shell comprising a different II-VI semiconductor material, as described in U.S. Pat. No. 6,207,229, incorporated herein by reference. However, the shell also interferes with the optical and electrical properties of the nanoparticles, decreasing quantum efficiency of the radiation and the production yield of the nanoparticles.

Furthermore, it has been difficult to form nanoparticles of a uniform size. Some researchers claimed to have formed nanoparticles in a solution having a uniform size based on transmission electron microscopy (TEM) measurements and based on approximating nanoparticle size from the position of the exciton peak in the absorption spectra of the nanoparticles. However, the present inventor has determined that both of these methods do not lead to an accurate determination of nanoparticle size in the solution.

TEM allows actual observation of a few nanoparticles precipitated on a substrate from a solution. However, since very few nanoparticles are observed during each test, the nanoparticle size varies greatly between observations of different nanoparticles from the same solution. Therefore, even if a single TEM measurement shows a few nanoparticles of a uniform size, this does not correlate to an entire solution of nanoparticles of a uniform size.

Using the absorption spectra exciton peak position to approximate nanoparticle size is problematic for a different reason. The exciton peak position does not show whether the individual nanoparticles in a solution are agglomerated into a large cluster. Thus, the size of the individual nanoparticles that is estimated from the location of the exciton peak in the absorption spectra does not take into account that the individual nanoparticles have agglomerated into clusters.

### BRIEF SUMMARY OF THE INVENTION

A preferred embodiment of the present invention provides a plurality of nanoparticles having a metal oxide or a semiconductor oxide surface region and a metal or semiconductor core region.

Another preferred embodiment of the present invention provides a plurality of uniformly doped nanoparticles having an average size between about 2 nm and about 100 nm with a size standard deviation of less than 60 percent of the average nanoparticle size determined by photon correlated spectroscopy (PCS) method.

Another preferred embodiment of the present invention provides a method of making nanoparticles, comprising providing a bulk material, grinding the bulk material into a powder having particles of a first size, providing the powder having particles of a first size into a solution, and providing an etching liquid into the solution to etch the particles of the first size to nanoparticles having a second size smaller than the first size.

Another preferred embodiment of the present invention provides a method of making nanoparticles, comprising providing semiconductor or metal nanoparticles into an oxidizing solution, and oxidizing the semiconductor or metal nanoparticles in the oxidizing solution to form a semiconductor oxide or a metal oxide surface region on the respective semiconductor or metal nanoparticles.

### BRIEF DESCRIPTION OF THE DRAWINGS

FIG. 1 is a three dimensional view of a magnetic data storage medium according to one preferred embodiment of the present invention.

FIG. 2 is a top view of optical data storage medium according to another preferred embodiment of the present invention.

FIG. 3 is a side cross sectional view of an optical cantilever device to another preferred embodiment of the present invention.

FIG. 4 is a side cross sectional view of an electroluminescent device according to another preferred embodiment of the present invention.

FIG. 5 is a side cross sectional view of a photodetector according to another preferred embodiment of the present invention.

FIGS. 6A and 6B are schematic illustrations of steps in a method of making nanoparticles according to the preferred embodiments of the present invention.

FIGS. 7-26 are PCS spectra from samples illustrating nanoparticle size distribution in water for silicon, silicon dioxide (SiO₂) and for silicon nanoparticles capped with SiO₂, made according to the preferred embodiments of the present invention.

### DETAILED DESCRIPTION OF THE PREFERRED EMBODIMENTS

The present inventor has realized that nanoparticles may be formed by a simple, room temperature process which includes grinding a bulk material to a powder and then etching the powder in a solution to achieve a desired nanoparticle size. Thus, the process generates the nanoparticles from a bulk solid at temperatures below 100 C, such as below 50 C, preferably at room temperature.

Due to the simplicity, uniformity and rapidness of this process, nanoparticles of any material can be fabricated in large quantities with very narrow size distribution compared to any other existing method, such as ball milling alone or pyrolysis. For example, metal, semiconductor and metal oxide or semiconductor oxide nanoparticles, such as silicon, silica, alumina and aluminum, nanoparticles may be synthesized using this method.

The term nanoparticles includes particles having an average size between about 2 and about 100 nm, preferably particles having an average size between about 2 and about 50 nm. Most preferably, the nanoparticles comprise quantum dots having an average size between about 2 and about 10 nm. Preferably, the first standard deviation of the size distribution is 60% or less, preferably 40% or less, most preferably 10 to 25% of the average particle size.

A method of making nanoparticles according to the first preferred embodiment includes providing a bulk material, such as chunk of a bulk material. The method further includes grinding the bulk material into a powder having particles of a first average size, such as nanoparticles and/or microparticles. The powder having particles of a first size is provided into a solution. An etching liquid is also provided into the solution to etch the particles of the first size to nanoparticles having a desired second size smaller than the first size.

The bulk material may have any suitable shape for grinding and may comprise any desired material that can form nanoparticles. For example, the bulk material may be a semiconductor bulk material, such as a Group IV (Si, Ge, SiC, SiGe), II-VI (CdS, ZnS, CdSe, ZnSe, ZnTe, CdTe), IV-VI (PbS, PbSe, PbTe) or a III-V (GaAs, GaP, GaN, InP, InAs) semiconductor material. Ternary and quaternary semiconductor nanoparticles, such as CdZnS, CdZnSe, CdZnTe, CdZnTeSe, CdZnSSe, GaAlAs, GaAlP, GaAlN, GalnN, GaAlAsP and GaAlInN for example, may also be used.

Preferably, the bulk material comprises a uniformly doped semiconductor bulk material, such as a uniformly doped single crystal, polycrystalline or amorphous semiconductor wafer, boule or layer formed on a substrate. Most preferably, the bulk material comprises least a portion of a silicon wafer uniformly doped with suitable Group III or Group V dopants, such as B, P, As and/or Sb.

Alternatively, the bulk material comprises a ceramic bulk material, such as a ceramic crystal. For example, the ceramic material may comprise silica, alumina, titania, zirconia, yttria stabilized zirconia, yttria, ceria, spinel (for example, MgO*Al₂O₃) and tantalum pentoxide, as well as other suitable ceramics having a more complex structure, such as radiation emitting phosphors (for example, YAG:Ce (Y₃Al₅O₁₂:Ce) and various halophosphate, phosphate, silicate, aluminate, borate and tungstate phosphors) and scintillators (for example, LSO, BGO, YSO, etc.). If desired, other materials, such as .quartz or glass may also be used.

Alternatively, the bulk material comprises a metal, such as a pure metal or a metal alloy, having any suitable shape, such as a bar, rod, etc. Any suitable metal may be used, such as Al, Fe, Cu, Ni, Au, Ag, Pt, Pd, Ti, V, Ta, W, Mn, Zn, Mo, Ru, Pb, Zr, etc. Preferably, the metal comprises a metal alloy (i.e., doped metal) having any suitable alloy composition, such as steel, Inconel, Permendur, and other suitable alloys.

The bulk material may be reduced to a powder by any suitable grinding method. For example, the bulk material may be ground into a powder by milling, such as ball milling. However, in a first preferred aspect of the first embodiment, the step of grinding comprises placing a chunk of the bulk material on an abrasive film and moving the chunk and the abrasive film relative to each other to grind the bulk material into a powder.

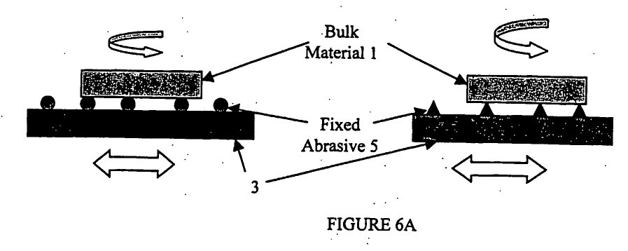

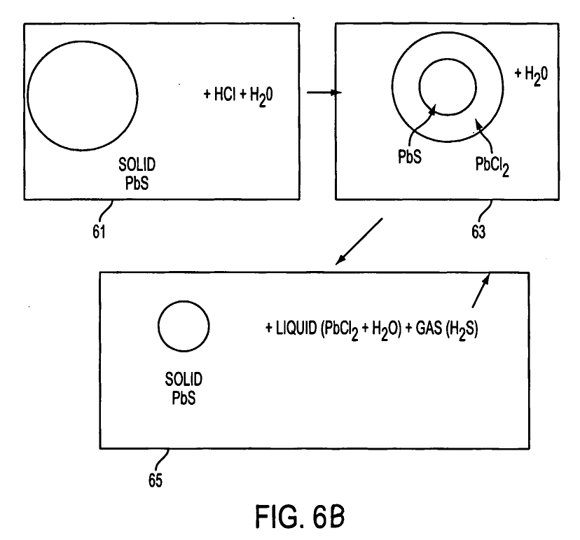

For example, as shown in FIG. 6A, a solid piece or chunk of bulk material 1 is moved over a fixed abrasive film 3 with spherical or sharp abrasive tips 5. The size of the mechanically removed particles is of the order of the tip dimensions. Unlike the ball-milling process, this process generates more uniform size particles, such as microparticles or nanoparticles. The particles are preferably suspended in a liquid during the grinding process, such as water or glycerol. Subsequently their sizes are tuned by a combination of chemical etching and optionally centrifugation, filtering through a porous medium, sonification and surface capping, as will be described in more detail below.

The etching liquid may be provided into the solution before or after the powder is provided into the solution. For example, the solution may comprise aqueous HCl, HF, NaOH or KOH where the solute is the etching liquid and water is a solvent. Alternatively, the etching liquid itself may comprise a first solution which is added to a second solution before or after the powder is added to the second solution.

Thus, nanoparticles or nanocrystals having sizes in the range of 2-100 nm and with size distribution in the range of 10-25% of the average size can be made using the method of the first preferred embodiment. Preferred examples for fabricating nanoparticles of different materials are briefly described below.

Polycrystalline chunks of Al, Si, silica and alumina were taken and ground on a 0.1 to 1 micron size diamond and silicon carbide fixed abrasive films. The abrasive film was rotated and/or the chunks were moved on the abrasive film. During the grinding process, the abrasive film was flushed with water and the abraded “primary” nanoparticles were collected in a container.

The primary nanoparticles were then etched in a solution using suitable chemical etchants such as KOH, HF, NaOH, HCl and other acids and bases (i.e., a suitable etching liquid is selected for each particular material). Optionally, surface capping was provided by standard anionic or cationic surfactants.

Thus, ground nanoparticle powder with a large average size and a non-uniform size distribution may be provided into a solution first. Then, the etching liquid is added to the solution and the solution is agitated, such as by a magnetic stirrer. The etching liquid reduces the size of the nanoparticles to the desired size by etching the nanoparticles. Thus, the etching “tunes” the nanoparticles to a desired size. The general reaction chemistries for the etching step of exemplary PbS and CdS nanoparticles are shown below:
PbS+H₂O+2HCl→PbCl₂+H₂S+H₂O (1)
CdS+H₂O+2HCl→CdCl₂+H₂S+H₂O (2)

A model depicting the size tuning of PbS nanoparticles is shown in FIG. 6B. First, PbS nanoparticles with a large size are provided into a water solution. Then HCl is added to the solution (box 61 in FIG. 6B). HCl reacts with the PbS nanoparticles and forms PbCl₂ and H₂S (box 63 in FIG. 6B). The etched PbS nanoparticles with the smaller and uniform size remain in the water. PbCl₂ remains dissolved in water while H₂S volatile gas escapes from the solution (box 65 in FIG. 6B).

The excess passivating element in the solution, such as sulfur, then repassivates the surface of the etched nanoparticles. By selecting an appropriate type and amount of etching medium, the large nanoparticles can be automatically etched down to a uniform smaller size. If the acid concentration is the solution exceeds the desired amount then the nanoparticles are completely dissolved.

Preferably, the etching liquid is diluted in water to form a first solution and then the first solution is added to a second solution in small amounts. For example, PbS nanoparticle size tuning is done by adding a dilute solution of HCl:H₂O (1:50 by volume percent, where 1 ml of HCl is dissolved in 50 ml of H₂O) to the water containing the nanoparticles. This HCl:H₂O solution is added to the water containing the nanoparticles in small amounts, such as in 2 ml amounts, to tune the nanoparticle size.

To narrow the size distribution, one or more purification or particle separation steps are preferably performed. One such particle separation step comprises centrifuging a container containing the solution after the etching step (i.e., centrifuging the solution containing the formed nanoparticles). Distilled water is added to the sample and the nanoparticles are agitated back into solution in an ultrasonic vibrator. The process of centrifuging and washing may be repeated a plurality of times, if desired.

The above solution is then filtered through mesh or filters after the steps of centrifuging and washing. The mesh or filter can be from made from randomly oriented stacks of cellulose, spherical columns of dielectric materials, polymers, nano-porous media (such as alumina or graphite).

An alternative method to make nanoparticles with a specific size is to decant the solution by storing it for several hours. A first set of heavy or large nanoparticles or nanoclusters settle at the bottom of the container. The second set of smaller nanoparticles still located in a top portion of the solution is separated from the first set of nanoparticles and is removed to a new container from the top of the solution. This process can be repeated several times to separate nanoparticles with different size. During each successive step, the original reagent solution is diluted with a liquid medium which does not dissolve the nanoparticles, such a water. The decanting step may be used instead of or in addition to the centrifuging and filtering steps.

After fabrication, storage and/or transportation, the nanoparticles may be suspended in fluid, such as a solution, suspension or mixture. Suitable solutions can be water as well as organic solvents such as acetone, methanol, toluene, alcohol and polymers such as polyvinyl alcohol. Alternatively, the nanoparticles are located or deposited on a solid substrate or in a solid matrix. Suitable solid matrices can be glass, ceramic, cloth, leather, plastic, rubber, semiconductor or metal. The fluid or solid comprises an article of manufacture which is suitable for a certain use.

The method of the first preferred embodiment is advantageous because it provides fabrication of uniformly doped nanoparticles (i.e., nanocrystals). Incorporating dopants (dopants are called “alloying elements” in metals) is very difficult and unreliable when nanoparticles are fabricated by the prior art high temperature chemical synthesis due to the fact that the number of surface and bulk atoms are almost similar. In the method of the first preferred embodiment, the dopants are already incorporated and chemically bonded to the host lattice in the bulk material. Hence dopants are uniformly distributed and present in almost all the nanoparticles. This is due to the fact that the original bulk material may be grown or fabricated at high temperature and in very high quality and ultra-pure form under equilibrium growth conditions. The rapid fragmentation of the bulk to nanoparticles during the grinding step ensures the high quality for the final nanoparticles. Thus, a rapid, large scale production of high quality nanoparticles is possible. Furthermore the initial size distribution of the nanoparticles is significantly narrower compared to nanoparticles fabricated by a ball mill process alone. The method of the first preferred embodiment is universal and can be used to create nanoparticles of any material.

The nanoparticles made by the method of the first preferred embodiment comprise nanoparticles having an average size between about 2 nm and about 100 nm with a size standard deviation of less than 60 percent of the average nanoparticle size determined by photon correlated spectroscopy (PCS) method. The PCS method has been used to determine the size of nanoparticles in a suspension. The size of the nanoparticles can also determined using Secondary electron Microscopy (SEM), Transmission Electron Microscopy (TEM) or Atomic Force Microscopy (AFM). Preferably, the nanoparticles have an average size between about 2 nm and about 10 nm with a size standard deviation of between about 10 and about 25 percent of the average nanoparticle size determined by photon correlated spectroscopy (PCS) method.

Most preferably, the nanoparticles are uniformly doped nanoparticles. In one preferred aspect of the first embodiment, the term “uniformly doped nanoparticles” means that each uniformly doped nanoparticle has a dopant concentration that varies by less than 5%, preferably less than 1% throughout its volume. In another preferred aspect of the first embodiment, the term “uniformly doped nanoparticles” means that the nanoparticles have an average dopant concentration that varies by less than 5%, preferably less than 1% among the nanoparticles. In other words, each nanoparticle from the plurality of nanoparticles has an average doping concentration that is within 5%, preferably within 1% of the other nanoparticles within the plurality of nanoparticles, such as a plurality of randomly sampled nanoparticles produced from the same batch of nanoparticles. The term “dopant” includes dopant ions in semiconductor nanoparticles, such as B, P, As or Sb in Si nanoparticles, dopant ions in metal oxide ceramic phosphor and scintillator nanoparticles, such as Ce³⁺ ions in a YAG nanoparticles, and alloying elements in metal alloys, such as C in Fe nanoparticles.

In a preferred aspect of the first embodiment, the nanoparticles are capable of being suspended in water without substantial agglomeration and substantial precipitation on container surfaces for at least 30 days, preferably at least 90 days. This means that at least 70%, preferably 95%, most preferably over 99% of the nanoparticles are suspended in water without agglomerating and precipitating on the bottom and walls of the container. It should be noted that the nanoparticles may also be suspended in liquids other than water without substantial agglomeration and substantial precipitation on container surfaces for at least 30 days, preferably for at least 90 days. The nanoparticles may be used in various fields of technology, such as nanotechnology, semiconductors, electronics, biotechnology, coating, agricultural and optoelectronics, as will be described in more detail below.

In a second preferred embodiment of the present invention, semiconductor or metal nanoparticle surface is modified to form a semiconductor oxide or metal oxide surface region. For example, a silicon nanoparticle surface may be modified to a silicon dioxide surface or an aluminum nanoparticle surface may be modified to an aluminum oxide surface, by suspending the nanoparticles in an oxidizing solution.

A method of making nanoparticles according to the second preferred embodiment comprises providing semiconductor or metal nanoparticles into an oxidizing solution and then oxidizing the semiconductor or metal nanoparticles in the oxidizing solution to form a semiconductor oxide or a metal oxide surface region on the respective semiconductor or metal nanoparticles. Of course the nanoparticle surface could also be modified to a nitride, such as a semiconductor nitride (such as silicon nitride) or metal nitride (such as aluminum nitride) by using a nitriding solution instead of an oxidizing solution.

Preferably, a bulk metal or semiconductor material is first ground as described above to form the semiconductor or metal nanoparticles prior to providing semiconductor or metal nanoparticles into an oxidizing (or nitriding) solution.

Any suitable oxidizing solution may be used. For example, for silicon nanoparticles, a dilute, aqueous NaOH or KOH solution may be used to oxidize the nanoparticles.

In one preferred aspect of the second embodiment, the same solution is used to etch and oxidize the nanoparticles. For example, an acidic aqueous solution having a pH below 7 contains both HF and NaOH in suitable amounts. As the ground semiconductor or metal nanoparticles are provided into the solution, the HF etches the nanoparticles to a desired size, until the reactive fluorine ions are exhausted. Then, the NaOH in the solution oxidizes the surface of the nanoparticles.

In another preferred aspect of the second embodiment, different solutions are used to etch and oxidize (or nitride) the nanoparticles. For example, the ground nanoparticles may first be introduced into a first solution containing an etching liquid, such as HF, with a pH below 7 to etch the nanoparticles to a desired size. The nanoparticles are then removed form the first solution and placed into a second oxidizing solution, such as a NaOH or KOH containing solution having a pH above 7 to oxidize the nanoparticles. Alternatively, the first solution is converted to the second solution by adding the oxidizing agent, such as NaOH or KOH, into the first solution after the end of the etching step. If it is desired to nitride the nanoparticles, then a nitriding solution, such as an aqueous ammonia solution, may be used instead.

The nanoparticles of the second preferred embodiment have a metal oxide or a semiconductor oxide surface region and a metal or semiconductor core region. The nanoparticles also contain a transition region located between a surface region and the core region. The oxygen to metal or semiconductor ratio in the transition region is maximum adjacent the surface region and gradually decreases toward the core region. Preferably, the core region contains no oxygen atoms or contains a trace amount of oxygen atoms, such as less than 1 atomic % oxygen.

Thus, semiconductor nanoparticles comprise a Si, Ge, SiGe, II-VI, IV-VI, or a III-V semiconductor core region, and a SiO₂, GeO₂, II-VI, IV-VI, or III-V oxide surface region. For example, Si nanoparticles have a Si core region, a SiO₂ surface region and a silicon rich SiO₂₋ₓ transition region, where x ranges from 2 adjacent to the surface region to about zero adjacent to the core region. Preferably, the Si core regions of the nanoparticles are uniformly doped with a suitable Group III or a Group V dopant.

The metal nanoparticles comprise a metal core region and a metal oxide surface region. For example, Al nanoparticles comprise an Al core region, an Al₂O₃ surface region, and an aluminum rich AlOₓ transition region, where x ranges from 3/2 adjacent to the surface region to about zero adjacent to the core region.

As in the first embodiment, the preferred nanoparticle average size is 2 to 100 nm with a 10 to 25% size distribution. The nanoparticles preferably have an average size between about 2 nm and about 100 nm with a size standard deviation of less than 60 percent of the average nanoparticle size measured by photon correlated spectroscopy (PCS) method.

The following preferred first through twenty sixth use embodiments provide preferred articles of manufacture which incorporate the nanoparticles made by the methods of the first and/or second manufacturing embodiments. It should be noted that while these articles of manufacture preferably -contain the nanoparticles of the first and second embodiments, as described above, they may also contain metal or insulating (such as ceramic) nanoparticles which are made by any other method, including by the prior art methods. In the first four preferred embodiments, the nanoparticles are provided into a fluid.

In a first preferred embodiment, the nanoparticles are placed into a polishing slurry. The nanoparticles are dispersed in the polishing slurry fluid. Since the nanoparticles have a very high surface hardness due to their small size, the nanoparticles function as an abrasive medium in the slurry fluid. If desired, another abrasive medium in addition to the nanoparticles may be added to the slurry. The polishing slurry may be used to polish any industrial articles, such as metal or ceramics. Preferably, the slurry is adapted to be used in a chemical-mechanical polishing apparatus used to polish semiconductor wafers and devices. In this case, in addition to the nanoparticles, the slurry also contains a chemical which chemically removes a portion of the semiconductor wafers and devices.

In a second preferred embodiment, the nanoparticles are placed into a paint. The nanoparticles are dispersed in the liquid base of the paint. Since the nanoparticles have a uniform size distribution, they provide a substantially uniform color to the paint. In a preferred aspect of the second embodiment, the liquid paint base is selected such that it evaporates after being coated on a surface, such as a wall, ceiling or floor. After the liquid base evaporates, a layer of nanoparticles is left on the surface such that the nanoparticles provide a color to the surface. The nanoparticles are very strongly adhered to the surface due to their small size. The nanoparticles are almost impossible to remove by physical means, such as brushes, paint knives or scrubbers, since the nanoparticle size is smaller than the grooves present in the surfaces of the brushes, paint knives or scrubbers. Thus, a chemical method, such as acid etching, is required to remove the nanoparticles from a surface. Therefore, the nanoparticle containing paint is especially adapted to function as a protective paint, such as a rust inhibiting primer paint (which is provided under a conventional paint layer) or a top coat paint (which is provided over a layer of conventional paint). Thus, the nanoparticle containing paint is especially adapted to coat outdoor structures, such as bridges, fences and buildings, since it adheres much better to surfaces than the conventional paints, primers and top coats.

In a third preferred embodiment, the nanoparticles are placed into an ink. The nanoparticles are dispersed in a liquid ink. As described above, the nanoparticles can provide a substantially uniform color to a liquid. Thus, by placing the nanoparticles into a ink, once the ink dries and the liquid base evaporates, an image is formed from a layer of nanoparticles. This image will have a very high adhesion to the surface on which it is printed. The ink may comprise computer printer (i.e., ink jet printer, etc.) ink, printing press ink, pen ink or tatoo ink.

In a fourth preferred embodiment, the nanoparticles are placed into cleaning composition. The nanoparticles are dispersed in the cleaning fluid. Since the nanoparticles have a high surface hardness, they add a significant scrubbing power to the cleaning fluid. The cleaning fluid may comprise any industrial cleaning fluid, such as a surface cleaning/scrubbing fluid or a pipe cleaning fluid.

In the first four preferred embodiments, the nanoparticles are provided into a fluid. In the following preferred embodiments, the nanoparticles are provided onto a surface of a solid material.

In the fifth preferred embodiment, the nanoparticles comprise a hardness or wear resistant coating located on at least a portion of a device. The device may be any device in which a hardness or wear resistant coating is desired. For example, the device may be a tool (such as a screwdriver or saw blade), a drill bit, a turbine blade, a gear or a cutting apparatus. Since the nanoparticles have a high surface hardness and a very strong adhesion to a substrate, a layer of nanoparticles provides an ideal hardness or wear resistant coating for a device. The coating may be formed by providing a fluid containing the nanoparticles and then evaporating or otherwise removing the fluid to leave a layer of nanoparticles on the device surface.

In the sixth preferred embodiment, the nanoparticles comprise a moisture barrier layer located on at least one surface of an article of manufacture. The moisture barrier layer has few or no pores for water or moisture to seep through the layer because the layer comprises a plurality of small size nanoparticles contacting each other. The size of the individual nanoparticles is much smaller than the size of a drop of moisture. Thus, a continuous layer of nanoparticles will resist penetration of moisture. The article of manufacture containing the nanoparticles may be apparel (i.e., coats, pants, etc. made of cloth or leather) or footwear (made of leather, cloth, rubber or artificial leather). Alternatively, the article of manufacture could comprise an edifice, such as a bridge, building, tent, sculpture, etc. For example, since the nanoparticle layer has a higher adhesion to a structure than conventional moisture barrier paint, using the nanoparticle moisture barrier would reduce or eliminate the requirement that the moisture barrier be the reapplied every few years (as is currently done with bridges). The moisture barrier layer may be deposited by providing a fluid containing the nanoparticles and then evaporating or otherwise removing the fluid to leave a layer of nanoparticles on the article surface. Preferably, the layer is formed on an outer surface of the article. If desired, the nanoparticle material could be selected which absorbs sunlight and generates heat when exposed to sunlight (i.e., CdTe nanoparticles). Alternatively, the material may be selected which traps heat emitted by a human body.

In a seventh preferred embodiment, the nanoparticles are provided in a composite ultra low porosity material. Preferably, such a material has a porosity below 10 volume percent, most preferably below 5 volume percent. The composite material comprises a solid matrix material and the nanoparticles incorporated into the matrix. The composite material may be formed by mixing a matrix material powder and nanoparticle powder together and then compressing the mixed powder to form a composite material. Since the nanoparticles have a small size, they occupy the pores in the matrix material to form an ultra low porosity composite material. The matrix material may comprise ceramic, glass, metal, plastic or semiconductor materials. The ultra low porosity material may be used as a sealant, such as a tire sealant. Alternatively, the composite material may be used as a filler in industrial and medical applications.

In an eighth preferred embodiment, the nanoparticles are provided in a filter. A nanoparticle powder may be compressed to form the filter. Alternatively, the nanoparticles may be added to a solid matrix material to form the filter. Since the nanoparticles have a small size, compressed nanoparticles or nanoparticles in a matrix have a low porosity. Thus, the nanoparticle filter has a very fine “mesh” and is able to filter very small particles. The porosity of the filter is greater than the porosity of the ultra low porosity material of the previous embodiment. Preferably, the filter is used to filter a liquid containing very small solid particles. The liquid containing the particles is poured through the filter, which traps particles above a predetermined size.

In a ninth preferred embodiment, the nanoparticles are provided in a composite high strength structural material. Since the nanoparticles have a high surface hardness and low porosity, the nanoparticles may be incorporated into a composite structural material having a solid matrix and nanoparticles dispersed in the matrix. The matrix material may comprise ceramic, glass, metal or plastic. The structural material may be used in buildings as supporting columns and walls and in bridges as the roadway and as supporting columns. The structural material may also be used to form parts of machinery and vehicles, such as cars and trucks.

In a tenth preferred embodiment, the nanoparticles are provided in an environmental sensor. The environmental sensor includes a radiation source, such as a lamp or laser, and a matrix material containing the nanoparticles. The matrix material may comprise liquid, gas or solid material. The sensor is exposed to an outside medium which affects the light emitting properties of the nanoparticles. For example, the sensor may comprise a pollution sensor which is exposed to atmosphere. The amount of pollution in the atmosphere affects the microenvironment of the nanoparticles, which in turn affects their radiation emission characteristics. The nanoparticles are irradiated with radiation, such as visible light or UV or IR radiation, from the radiation source. The radiation emitted and/or absorbed by the nanoparticles is detected by a detector. A computer then determines the amount of pollution present in the atmosphere based on the detected radiation using a standard algorithm. The sensor may also be used to sense gas components and compositions other than the amount of pollution in the atmosphere.

The nanoparticles may also be used in lighting applications. The eleventh through the thirteenth embodiments describe the use of the nanoparticles in lighting applications.

In the eleventh preferred embodiment, nanoparticles are used as a light emitting medium in a solid state light emitting device, such as a laser or a light emitting diode. In these applications, a current or voltage is provided to the nanoparticles from a current or voltage source. The current or voltage causes the nanoparticles to emit light, UV or IR radiation, depending on the nanoparticle material and size.

In the twelfth preferred embodiment, nanoparticles are used to provide support for organic light emitting material in an organic light emitting diode. An organic light emitting diode contains an organic light emitting material between two electrodes. The organic light emitting material emits light when current or voltage is applied between the electrodes. The light emitting organic material may be a polymer material or small dye molecules. Both of these organic materials have poor structural characteristics and impact resistance, which lowers the robustness of the organic light emitting diodes. However, these organic light emitting materials may be incorporated in a matrix of nanoparticles which provides the desired structural characteristics and impact resistance. Since the nanoparticles have the same or smaller size than the dye or polymer molecules, the nanoparticles do not interfere with the light emitting characteristics of the diode.

In the thirteenth preferred embodiment, nanoparticles are used in a fluorescent lamp in place of a phosphor. In a conventional fluorescent lamp, a phosphor is coated on an inner surface of a shell of the lamp. The phosphor absorbs UV radiation emitted by a radiation source, such as mercury gas located in the lamp shell, and emits visible light. Since the certain ceramic nanoparticles have the ability to absorb UV radiation emitted by the radiation source and to emit visible light, these nanoparticles may be located on at least one surface of the lamp shell. Preferably, the layer of nanoparticles coated on the lamp shell contains nanoparticles which emit different color light, such that the combined light output of the nanoparticles appears as white light to a human observer. For example, the different color light emission may be obtained by mixing nanoparticles having a different size and/or nanoparticles of different materials.

The nanoparticles may also be used in magnetic data storage applications. The fourteenth and fifteenth preferred embodiments describe the use of the nanoparticles in magnetic data storage applications.

In the fourteenth preferred embodiment, the nanoparticles are used in a magnetic data storage device. This device includes a magnetic field source, such as a magnet, a data storage medium comprising the nanoparticles, a photodetector. A light source is used to illuminate the nanoparticles. The magnetic field source selectively applies a localized magnetic field source to a portion of the data storage medium. The application of the magnetic field causes the nanoparticles exposed to the field to change their light or radiation emission characteristics or to quench emission of light or radiation all together. The photodetector detects radiation emitted from the nanoparticles in response to the application of a magnetic field by the magnetic field source.

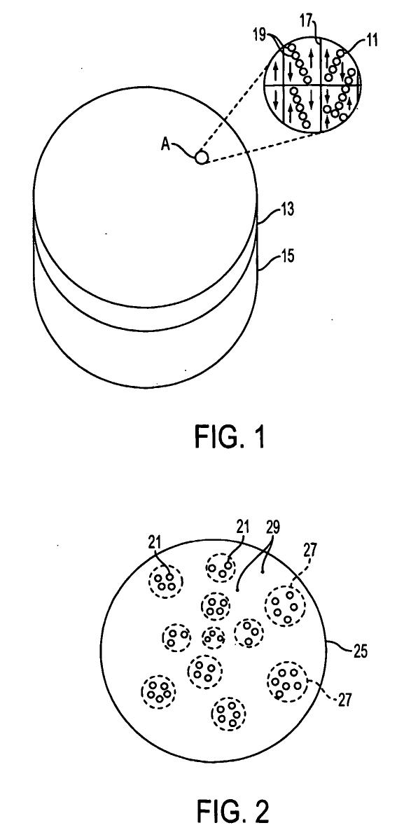

In the fifteenth preferred embodiment, the nanoparticles are used in a magnetic storage medium containing a magnetic material. The magnetic material may be any magnetic material which can store data by the alignment of the directions of the spins in the material. Such magnetic materials include, for example, cobalt alloys, such as CoPt, CoCr, CoPtCr, CoPtCrB, CoCrTa and iron alloys, such as FePt and FePd. In one preferred aspect of the fifteenth embodiment, the nanoparticles 11 are randomly mixed throughout a layer of magnetic material 13 formed on a substrate 15, as shown in FIG. 1. The substrate 15 may be glass, quartz, plastic, semiconductor or ceramic. The randomly dispersed nanoparticles are located within the magnetic domains in the magnetic material. The domains are separated by the domain walls. A few domain walls are shown by lines 17 in the close up of area “A” in FIG. 1 The dispersed nanoparticles form barrier layers 19 within the domains. The barrier layers form domain walls in the magnetic material. Therefore, the addition of the nanoparticles has the effect of subdividing the domains in the magnetic material into a plurality of “subdomains” each of which is capable of storing one bit of data (shown as spin arrows in FIG. 1). Thus, the addition of the nanoparticles increases the data storage density of the magnetic material by decreasing the domain size in the magnetic material.

In a second preferred aspect of the fifteenth embodiment, the magnetic storage medium comprises a substrate containing the nanoparticles doped with atoms of the magnetic material. Each nanoparticle is adapted to store one bit of data. Thus, small nanoparticles of magnetic material are encapsulated in the nanoparticles. In this case, the size of one bit of data storage is only as big as the nanoparticle. The magnetic nanoparticles may be doped into the nanoparticles using any known doping techniques, such as solid, liquid or gas phase diffusion, ion implantation or co-deposition. Alternatively, the magnetic nanoparticles may be encapsulated within the nanoparticles by a plasma arc discharge treatment of nanoparticles in contact with magnetic nanoparticles. Similar methods have been previously disclosed for encapsulating magnetic particles in carbon and buckytube shells (see U.S. Pat. Nos. 5,549,973, 5,456,986 and 5,547,748, incorporated herein by reference).

In the sixteenth preferred embodiment, the nanoparticles are used in an optical data storage medium, as shown in FIG. 2. Clusters of nanoparticles 21 are arranged in predetermined patterns on a substrate 25, such that first areas 27 of the substrate 25 contain the nanoparticles 21 while the second areas 29 of the substrate 25 do not contain the nanoparticles 21. The nanoparticles 21 in a solution may be selectively dispensed from an ink jet printer or other microdispenser to areas 27 on the substrate. After the solvent evaporates, a cluster of nanoparticles remains in areas 27. The substrate 25 may be a glass, quartz, plastic, semiconductor or ceramic substrate. Preferably, the substrate 25 is shaped as a disk, similar to a CD. The data from the storage medium is read similar to a CD, by scanning the medium with a laser or other radiation source. The nanoparticles 21 reflect and/or emit light or radiation differently than the exposed substrate areas 29. Therefore, when the substrate is scanned by a laser, a different amount and/or wavelength of radiation is detected from areas 27 than areas 29 by a photodetector. Thus, areas 27 correspond to a “1” data value, while areas 29 correspond to a “0” data value, or vise-versa (i.e., each cluster of nanoparticles 21 is a bit of data). Therefore, the nanoparticles 21 function similar to bumps in a conventional CD or as a material of a first phase in a phase change optical disk. The areas 27 may be arranged in tracks or sectors similar to a CD for ease of data read out.

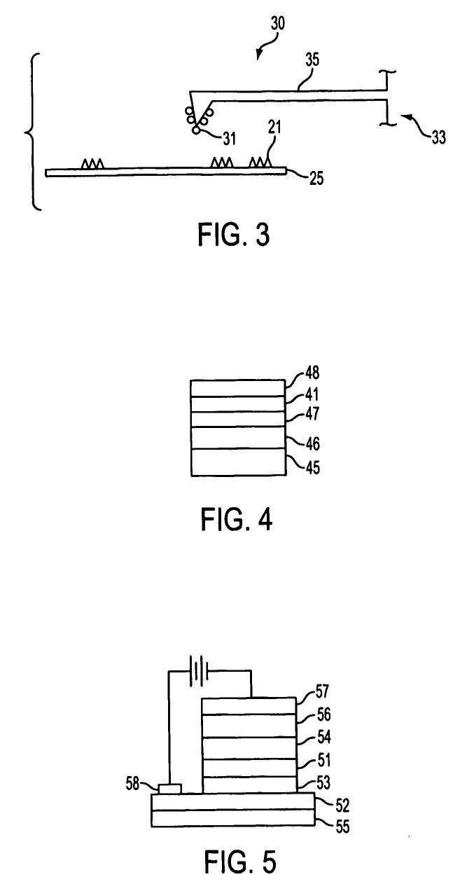

The optical data storage medium described above may be used in combination with an optical system of the seventeenth preferred embodiment. The optical system 30 includes at least one microcantilever 35 and light emitting nanoparticles 31 located on a tip of the at least one microcantilever, as shown in FIG. 3. The microcantilever 35 may be an atomic force microscope (AFM) microcantilever or a similar microcantilever that is not part of an AFM. For example, the microcantilever 35 may be conductive or contain conductive leads or wires which provide current or voltage to the nanoparticles to cause them to emit light or radiation. The base 33 of the microcantilever is connected to a voltage or current source. The microcantilever 35 may be scanned over the substrate 25 containing the nanoparticles 21 of the previous embodiment. The light emitting nanoparticles 31 on the cantilever irradiate the substrate 25, and the emitted and/or reflected light is detected by a photodetector and analyzed by a computer to read out the data. Of course, the optical system 30 may be used to read data from a conventional CD or phase change optical disk rather than from the medium of the previous embodiment. Furthermore, one or more microcantilevers 35 may be incorporated into an AFM to study surfaces of materials. In this case, the AFM may be used to study the interaction of light or radiation emitted by the nanoparticles 31 and the surface being studied.

In the eighteenth through the twenty first preferred embodiments, the nanoparticles are used in an optoelectronic component.

In the eighteenth preferred embodiment, the light emitting nanoparticles are used in an optical switch. In the switch, the light emitting nanoparticles are arranged on a substrate and are connected to a voltage or current source which provides the voltage or current for the light (or radiation) emission. A source of magnetic field, such as a magnet, is provided adjacent to the nanoparticles. When the magnet is turned on, it extinguishes radiation emitted by the nanoparticles.

In the nineteenth preferred embodiment, the nanoparticles are used in an electroluminescent device, such as the electroluminescent device illustrated in U.S. Pat. No. 5,537,000, incorporated herein by reference. The electroluminescent device 40 includes a substrate 45, a hole injection layer 46, a hole transport layer 47, an electron transport layer 41 and an electron injection layer 48, as illustrated in FIG. 4. An voltage is applied between layers 46 and 48. The voltage generates holes in layer 46 and electrons in layer 48. The holes and electrons travel, through layers 47 and 41 and recombine to emit light. Depending on the applied voltage, the recombination occurs either in layer 41 to emit red light or in layer 47 to emit green light. The electron transport layer 41 comprises a layer of nanoparticles, such as II-VI nanoparticles. The hole injection layer 46 comprises a conductive electrode, such as indium tin oxide. The hole transport layer 47 comprises an organic polymer material, such as poly-p(paraphenelyne). The electron injection layer 48 is a metal or heavily doped semiconductor electrode, such as a Mg, Ca, Sr or Ba electrode.

In a twentieth preferred embodiment of the present invention, the nanoparticles are used in a photodetector 50, such as a photodetector described in U.S. Pat. No. 6,239,449, incorporated herein by reference. As shown in FIG. 5, the photodetector is formed on a substrate 55. A first heavily doped contact layer 52 is formed on the substrate. A first barrier layer 53 is formed on the contact layer 52. One or more nanoparticle layers 51 are formed on the barrier layer 53. A second barrier layer 54 is formed on the nanoparticle layer(s) 51. A second heavily doped contact layer 56 is formed on the second barrier layer 54. Electrodes 57 and 58 are formed in contact with the contact layers 52, 56. The barrier layers 53, 54 are doped to provide charge carriers and for conductivity. The barrier layers 53, 54 have a higher band gap than the nanoparticles 51. Incident light or radiation excites charge carriers (i.e., electrons or holes) in the nanoparticles to an energy higher than the energy of the bandgap of the barrier layers 53, 54. This causes a current to flow through the photodetector 50 from the emitter electrode to a collector electrode in response to the incident light or radiation with the help of an external voltage applied between the electrodes.

In a twenty first preferred embodiment, the nanoparticles are used in a transmission grating. The nanoparticles are arranged on a transparent substrate in a form of a grating. Since the nanoparticles have a very small size, the grating may be formed with a period smaller than the wavelength of light or radiation that will be transmitted through the grating. Such gratings may be used in waveplates, polarizers or phase modulators. The gratings may be formed by patterning the nanoparticles on the substrate using submicron optical, x-ray or electron beam lithography or by placing individual nanoparticles on the substrate using an AFM or a scanning tunneling electron microscope.

In a twenty second preferred embodiment, the nanoparticles are used in an optical filter. The optical filter may comprise a glass, plastic or ceramic transparent matrix with interdispered nanoparticles. Since the nanoparticles absorb a radiation having a wavelength greater than a cutoff wavelength based on the material and size of the nanoparticles, the filter may be tailored to filter a particular range of light or UV radiation wavelengths depending on the material and size of the nanoparticles. Furthermore, the nanoparticles may be used to provide a color to a particular solid material, such as stained or colored glass.

In the twenty third preferred embodiment, the nanoparticles are used in electronic devices, such as transistors, resistors, diodes, and other nanodevices. For example, the nanoparticles may be used in a single electron transistor, as described in U.S. Pat. No. 6,057,556, incorporated herein by reference. The nanoparticles are located on a substrate between a source and a drain electrode. The nanoparticles comprise a channel of the single electron transistor. A plurality of nanoscale gate electrodes are provided over or adjacent to the nanoparticles. This device functions on the principle of controlled correlated single electron tunneling between the source and drain electrodes through the potential barriers between the nanoparticles. A single electron gate circuit can be constructed using this device, where logical “1” and “0” are identified by the presence or absence of an electron.

An example of a nanodevice array is a chip architecture termed cellular automata. With this architecture, the processor portion of the IC is made up of multiple cells. Each of the cells contains a relatively small number of devices, which communicate only with their nearest-neighbor cells. This architectural approach eliminates the need for long intercellular connections, which ultimately put a ceiling on the fastest processing capabilities of an electronic chip. Each cell would consist of approximately five nanoparticles or quantum dots.

In the twenty fourth preferred embodiment, the nanoparticles are used as a code or a tag. For example, the nanoparticles may be fashioned into a miniature bar code by AFM, STM or lithography. This bar code may be formed on small items, such as integrated circuits, and may be read by a miniature bar code reader. Of course the code may have symbols other than bars. In another example, the nanoparticles may be used as a tag (i.e., where the nanoparticles are not formed into a particular shape). Since a small amount of the nanoparticles is invisible to the human eye, the nanoparticle code or tag may be added to an item which must be authenticated, such as currency, a credit card, an identification card or a valuable object. To authenticate the item, the presence of the nanoparticles on or in the item is detected by a microscope or by an optical detector. Furthermore, nanoparticles of a certain size which emit a particular wavelength of light may be used to distinguish different objects. Combinations of different nanoparticle sizes which emit a combination of different wavelengths may be used to emit an optical code for more precise identification of the item.

In the twenty fifth preferred embodiment, the nanoparticles are used as sensor probes. For example, a sensor probe may be formed by bonding nanoparticles to affinity molecules using linking agents, as described in U.S. Pat. Nos. 6,207,392, 6,114,038 and 5,990,479, incorporated herein by reference. The affinity molecules are capable of selectively bonding with a predetermined biological or other substance. In response to an application of energy, the nanoparticles emit light or radiation which is detected by a detector. Thus, the presence, location and/or properties of the predetermined substance bound to the affinity molecule may be determined. The linking agents may be polymerizable materials, such as N-(3-aminopropyl)3-mercapto-benzamide. The affinity molecules, such as antibodies, are capable of selectively binding to the predetermined biological substance being detected, such as a particular antigen, etc.

In a twenty sixth preferred embodiment, the nanoparticles are attached to a polishing or grinding pad, such as a chemical mechanical polishing pad used for semiconductor device polishing. In this embodiment, semiconductor, metal or ceramic nanoparticles are attached to the polishing or grinding surface of the polishing pad, such as a cloth, plastic, ceramic or paper pad. Nanoparticles having the same composition as the layer being polished or ground are preferred. For example, silicon, silicon dioxide and silicon nitride nanoparticles, respectively, may be used on polishing pads used to polish silicon, silicon dioxide and silicon nitride, respectively, because these nanoparticles are not contaminants for the layer being polished.

The specific examples of nanoparticles made according to the methods of the preferred embodiments of the present invention will now be described. These specific examples are provided for illustration only and should not be considered limiting on the scope of the invention.

### EXAMPLE 1

Fabrication of silicon nanoparticles by the method of the first preferred embodiment. A silicon wafer was grounded by 0.1 micron (1000 nm) size fixed abrasive diamond film (purchased from South Bay Technology, Inc.) located a polishing plate for 3 minutes with water as a particle dispersant. The water was poured on the film during grinding and collected in a plastic container during the grinding by placing the polishing plate inside the container.

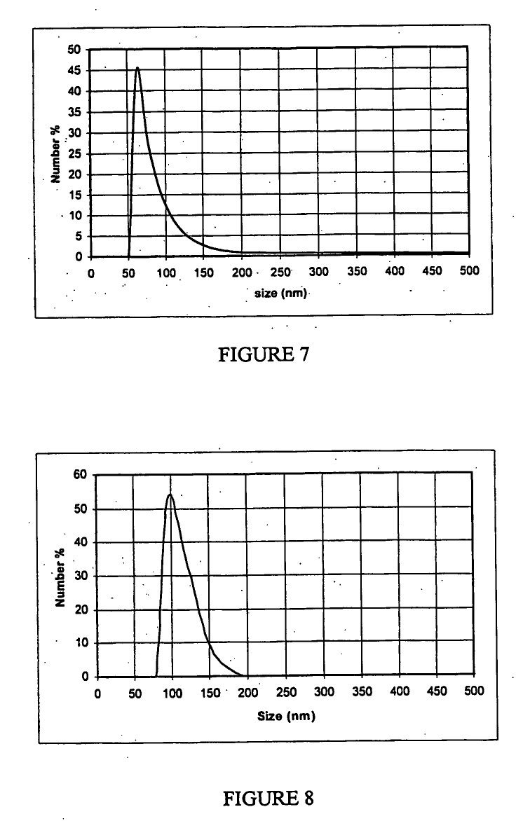

FIG. 7 shows the particle size distribution of silicon obtained in water using the process described above. The particles have a peak size of between 50 and 100 nm and a wide size distribution. FIG. 8 shows the particle size distribution of silicon obtained in water using the process described above and after 5 minutes of etching in HF:H₂O (1:50 by volume) solution. It clearly shows that the small and big particles are dissolved, and the size distribution is narrowed. For this process, the HF was added in measured quantity to the solution of FIG. 7.

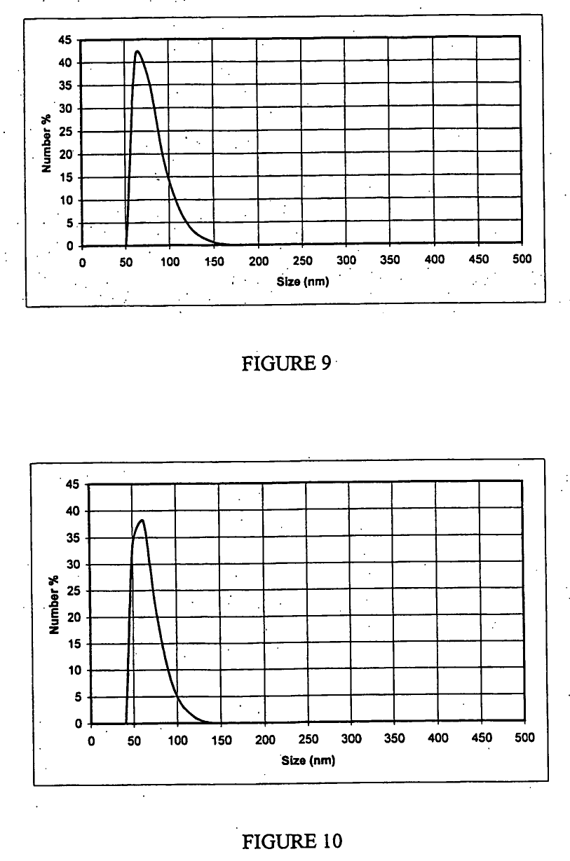

FIG. 9 shows the particle size distribution after further etching for 5 minutes by adding HF:H₂O (1:50 by volume) into solution of FIG. 8. FIG. 10 shows the particle size distribution after further etching for 5 minutes by adding HF:H₂O (1:50 by volume) into solution of FIG. 9. The peak size of the nanoparticles decreased in FIGS. 9 and 10 compared to that of FIG. 8.

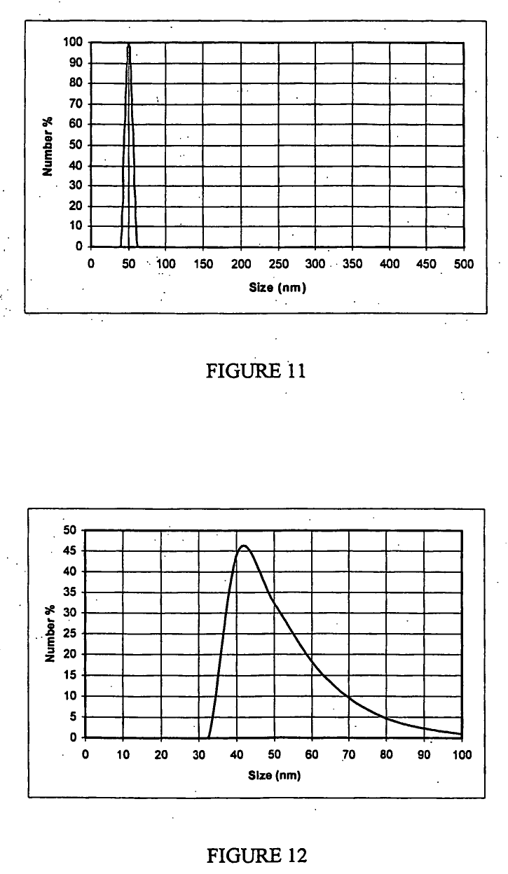

FIG. 11 shows the particle size distribution of silicon in water after centrifuging the solution of FIG. 9 for 2 minutes and extracting the top 50% of the liquid. The particle size distribution was narrowed and the peak size was decreased.

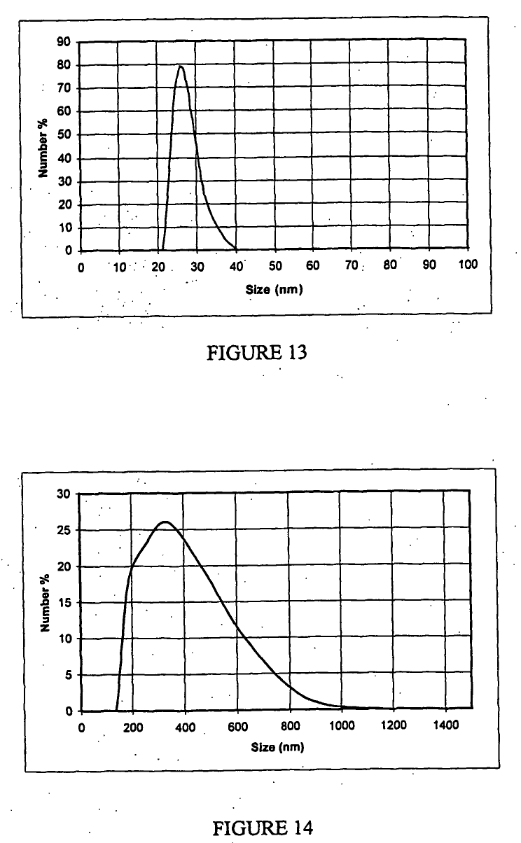

FIG. 12 shows the particle size distribution after further etching for 5 minutes by adding HF:HNO₃:CH₃COOH (3:5:3 by volume) into solution of FIG. 10. FIG. 13 shows the particle size distribution after further etching for 5 minutes by adding HF:H₂O (1:50 by volume) into solution of FIG. 11. The peak particle size and size distribution were decreased in both instances.

Thus, nanoparticles with a peak or average size of 25-60 nm and a size distribution of 10-30 nm could be obtained by selecting suitable etching and filtering steps. The particle size could be reduced further with additional etching and/or purification steps.

### EXAMPLE 2

Fabrication of silicon nanoparticles and a SiO₂ cap (i.e., silicon core with a silica surface region) according to the second preferred embodiment.

A silicon wafer was grounded by a ball milling process for 48 hours and the powder was suspended in water. FIG. 14 shows the initial particle size distribution of silicon suspended in water using the process described above. The size distribution is very wide in spite of longer grinding times compared to the first example (3 minutes).

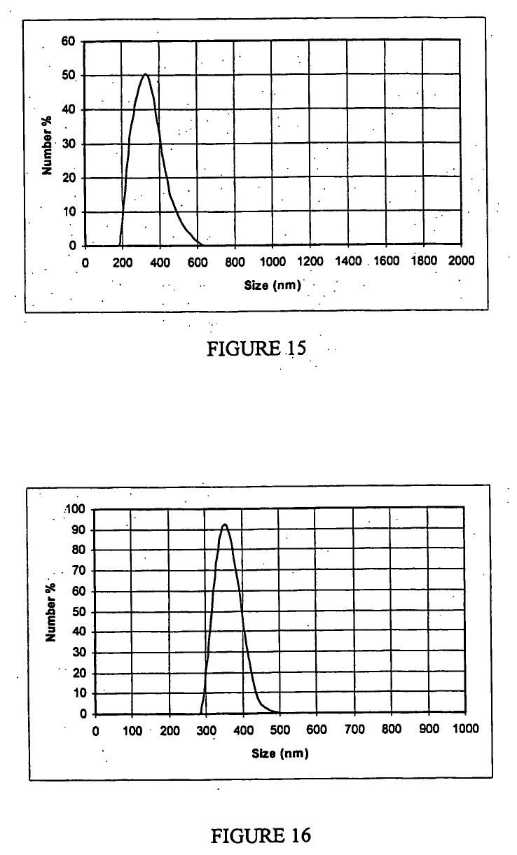

FIG. 15 shows the particle size distribution of silicon obtained in water using the process described with respect to FIG. 14 above and after 5 minutes of etching in HF:H₂O (1:50 by volume) solution. For this process the HF was added in measured quantity to the solution of FIG. 14. The particle size distribution was narrowed significantly.

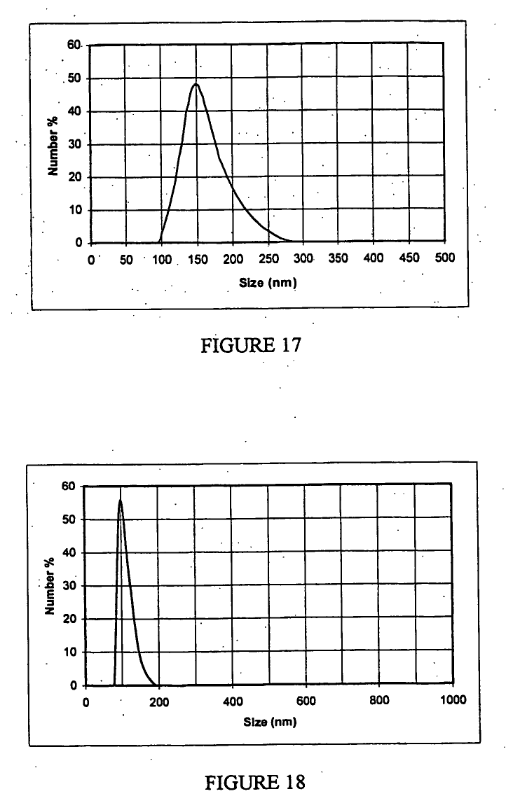

FIG. 16 shows the particle size distribution after further etching for 5 minutes by adding HF:H₂O (1:50 by volume) into solution of FIG. 15. FIG. 17 shows the particle size distribution after further etching for 5 minutes by adding HF:H₂O (1:50 by volume) into solution of FIG. 16. The peak particle size and distribution were narrowed significantly.

FIG. 18 shows the particle size distribution of silicon in water after centrifuging the solution of FIG. 17 for 2 minutes and extracting the top 50% of the liquid. The peak particle size and distribution were narrowed significantly.

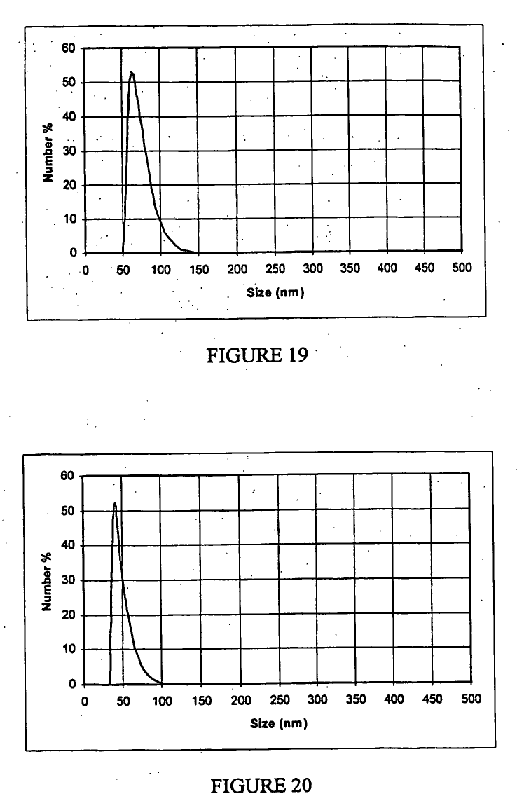

FIG. 19 shows the particle size distribution after further etching for 5 minutes by adding HF:H₂O (1:50 by volume) into solution of FIG. 18. FIG. 20 shows the particle size distribution after further etching for 5 minutes by adding HF:H₂O (1:50 by volume) into solution of FIG. 19. The peak particle size and distribution were narrowed significantly.

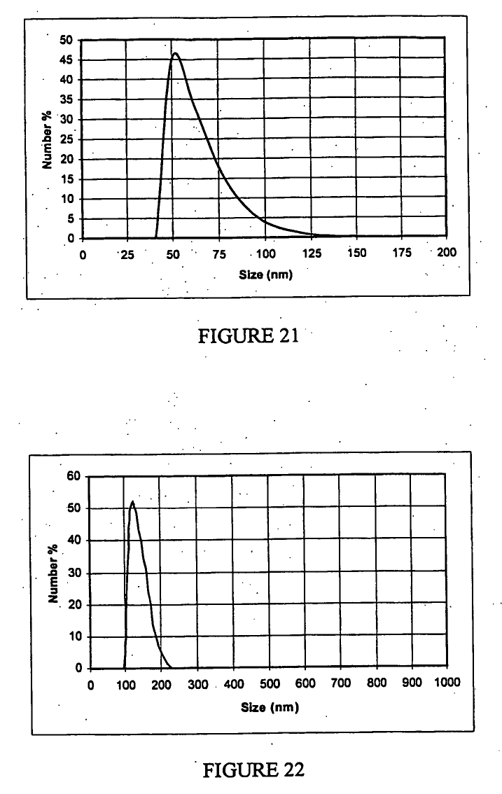

FIG. 21 shows the particle size distribution after adding NaOH in solution of FIG. 20 to change the pH from 5.5 to 8. The silicon particles were oxidized to form core-shell Si/SiO₂ nanoparticles by this process, and the solution appeared whitish.

### EXAMPLE 3

Fabrication of SiO₂ nanoparticles using the method of the first preferred embodiment. A quartz (silica) plate was grounded by 0.1 micron (1000 nm) size fixed abrasive diamond film (purchased from South Bay Technology, Inc.) for 3 minutes with water as a particle dispersant. The water was poured on the film during grinding and collected in a plastic container during the grinding by placing the polishing plate inside the container. FIG. 22 shows the particle size distribution of SiO₂ obtained in water using the process described above.

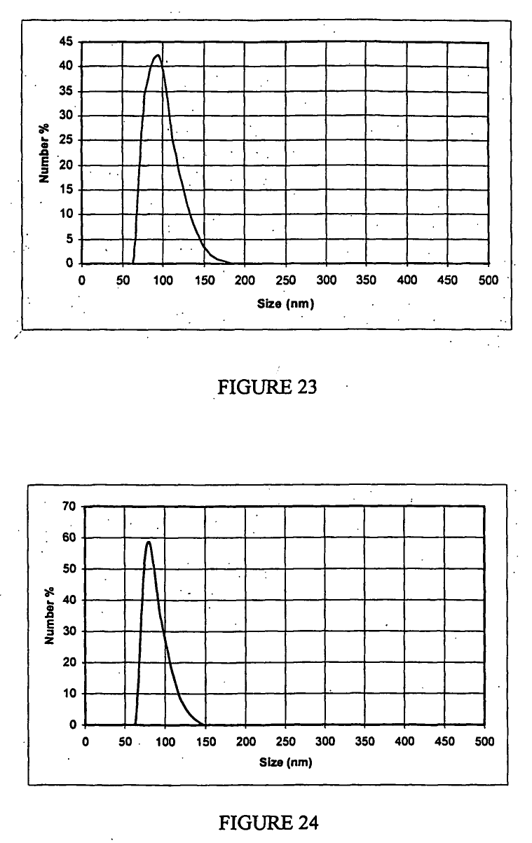

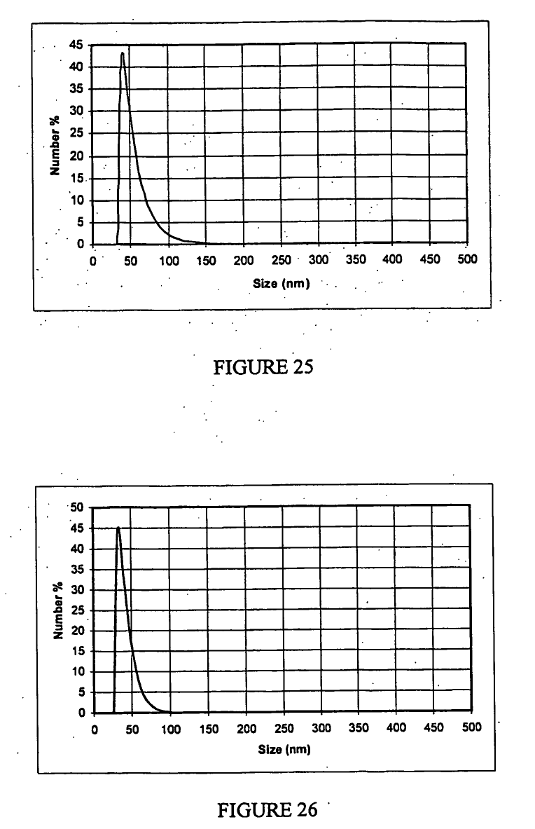

FIG. 23 shows the particle size distribution after 5 minutes of etching in HF:H₂O (1:50 by volume) solution. The HF was added in measured quantity to the solution of FIG. 22. FIG. 24 shows the particle size distribution after further etching for 5 minutes by adding HF:H₂O (1:50 by volume) into solution of FIG. 23. FIG. 25 shows the particle size distribution after further etching for 5 minutes by adding HF:H₂O (1:50 by volume) into solution of FIG. 24. The peak particle size and distribution were narrowed significantly by the controlled etching.

FIG. 26 shows the particle size distribution of silicon dioxide in water after centrifuging the solution of FIG. 25 for 2 minutes and extracting the top 50% of the liquid. The peak particle size and distribution were further narrowed.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. It is intended that the scope of the invention be defined by the claims appended hereto, and their equivalents.

All of the publications and patent applications and patents cited in this specification are herein incorporated in their entirety by reference.

1-52. (canceled)

53. A plurality of nanoparticles, wherein:
the nanoparticles have an average size below about 100 nm with a size standard deviation of less than 60 percent of the average nanoparticle size determined by photon correlated spectroscopy (PCS) method; and
the nanoparticles comprise ceramic, metal or uniformly doped semiconductor nanoparticles.

54. The nanoparticles of claim 53, wherein the nanoparticles have an average size between about 2 nm and about 10 nm with a size standard deviation of between about 10 and about 25 percent of the average nanoparticle size determined by photon correlated spectroscopy (PCS) method.

55. The nanoparticles of claim 53, wherein the nanoparticles comprise uniformly doped semiconductor nanoparticles.

56. The nanoparticles of claim 55, wherein the nanoparticles comprise silicon nanoparticles uniformly doped with a suitable Group III or Group V dopants.

57. The nanoparticles of claim 53, wherein:
the nanoparticles comprise uniformly doped nanoparticles;
each uniformly doped nanoparticle has a dopant concentration that varies by less than 5% throughout its volume; and
the uniformly doped nanoparticles have an average dopant concentration that varies by less than 5% among the nanoparticles.

58. The nanoparticles of claim 53, wherein the nanoparticles are capable of being suspended in water without substantial agglomeration and substantial precipitation on container surfaces for at least 30 days.

59. The nanoparticles of claim 53, wherein the nanoparticles comprise ceramic or metal nanoparticles.

60. The nanoparticles of claim 59, wherein the nanoparticles comprise ceramic nanoparticles.

61. The nanoparticles of claim 60, wherein the nanoparticles comprise uniformly doped ceramic nanoparticles.

62. The nanoparticles of claim 59, wherein the nanoparticles comprise metal nanoparticles.

63. The nanoparticles of claim 62, wherein the nanoparticles comprise uniformly alloyed metal nanoparticles.

64. A method of making nanoparticles, comprising combining a powder having particles of a first size with an etching liquid to etch the particles of the first size to nanoparticles having a second size smaller than the first size.

65. The method of claim 64, further comprising:
providing a bulk material; and
grinding the bulk material into the powder having particles of the first size.

66. The method of claim 65, wherein the step of grinding comprises placing a chunk of the bulk material on an abrasive film and moving the chunk and the abrasive film relative to each other to grind the bulk material into the powder.

67. The method of claim 65, wherein the step of grinding comprises ball milling the bulk material.

68. The method of claim 65, wherein the bulk material comprises a uniformly doped semiconductor bulk material.

69. The method of claim 68, wherein the bulk material comprises at least a portion of a silicon wafer uniformly doped with suitable Group III or Group V dopants.

70. The method of claim 64, wherein the particles comprise semiconductor particles.

71. The method of claim 64, wherein the particles comprise ceramic particles.

72. The method of claim 64, wherein the particles comprise pure metal or metal alloy particles.

73. The method of claim 64, wherein:
the nanoparticles have an average size of 50 nm or less; and
the method is conducted at a temperature below 100 C.

74. The method of claim 64, wherein the step of combining the powder with the etching liquid comprises combining the powder with the etching liquid in a solution.

75. The method of claim 74, wherein:
the solution comprises an aqueous solution;
the etching liquid comprises HCl, KOH, HF or NaOH; and
the step of combining the powder with the etching liquid in a solution comprises providing the powder into water followed by providing the etching liquid into the water.

76. The method of claim 64, further comprising incorporating the nanoparticles into an article of manufacture.

77. A polishing or grinding pad comprising a pad material and nanoparticles attached to a surface of the pad material.

78. The pad of claim 77, wherein:
the pad comprises a polishing pad; and
the nanoparticles comprise silicon, silicon dioxide or silicon nitride nanoparticles.

79. A chemical mechanical polishing method, comprising:
placing a device to be polished onto a first surface of the polishing pad of claim 77;
providing a chemical mechanical polishing fluid onto the first surface of the polishing pad; and
chemically mechanically polishing the device.

80. The method of claim 79, wherein:
the polishing fluid contains nanoparticles;
the polishing fluid is provided to the pad prior to placing the device onto the first surface of the pad; and
the device comprises a semiconductor device.
